(19) United States
(12) Patent Application Publication
(10) Pub. No.: US 2015/0245199 A1
(43) Pub. Date: Aug. 27, 2015

(54) PRIVACY RESTRICTED PHOTO GALLERY NAVIGATION FOR MOBILE DEVICES

(71) Applicant: Jared Blitzstein, Limerick, PA (US)

(72) Inventor: Jared Blitzstein, Limerick, PA (US)

(21) Appl. No.: 14/190,994

(22) Filed: Feb. 26, 2014

(51) Int. Cl. H04W 12/02; G06F 21/62

(52) U.S. Cl. CPC H04W 12/02; G06F 21/6245; H04W 12/06

(57) ABSTRACT

A photo gallery user interface in mobile devices having features for restricting access to private photos and other sensitive data while intentionally sharing non-private photos and/or other data is disclosed. A mechanism is provided for locking one or more photos in a gallery out of view before relinquishing possession of the device to viewers. The user may scroll or slide through multiple photos stored on the device and indicate which photos will not be available to the viewer. A method and a system for privacy restricted photo navigation for a mobile device selects a private image from an image gallery to restrict sharing with viewers, scales back the private image to reveal an option to select an additional private image, locks the selected private image(s) from viewing and unlocks the selected private images for viewing when a Personal Identification Number (PIN) is correctly entered.

### TECHNICAL FIELD

The present application relates generally to the technical field of wireless communication devices and, in one specific example, to a user interface for photo viewing.

### BACKGROUND

The proliferation of wireless devices has given rise to displaying and sharing of photographs in all types of social settings. Especially, when cameras are integrated in the wireless devices. Passing of cell phones and other personal devices from person to person for the purpose of viewing photos has become a widely practiced behavior in contemporary workplaces, schools, restaurants, and other environments. Many devices are capable of storing hundreds or even thousands of personal pictures, texts, “sexts”, emails and other sensitive information. Once a device has been passed for viewing, features for restricting access to other personal photographs and information are currently unavailable, resulting in the unintentional sharing of potentially damaging, confidential, or at the least, embarrassing photographs and other data. Thus, there is a need for a convenient and user friendly feature to restrict browsing of private photos in a gallery on a mobile device by the owner of the device, as well as a mechanism for locking out access to other applications, any time possession of a device has been relinquished by the owner for purposes of intentional sharing.

### BRIEF DESCRIPTION OF THE DRAWINGS

Some embodiments are illustrated by way of example and not limitation in the figures of the accompanying drawings in which:

FIG. 1 is a network diagram illustrating a network environment suitable for Privacy Restricted Photo Gallery Navigation for Mobile Devices, according to some example embodiments;

FIG. 2 is a high level block diagram illustrating components for Privacy Restricted Photo Gallery Navigation for Mobile Devices, according to some example embodiments;

FIG. 3 Shows a block diagram of a high level overview flow chart of Privacy Restricted Photo Gallery Navigation for Mobile Devices, according to some example embodiments;

FIGS. 4-10 illustrate user interfaces for Privacy Restricted Photo Gallery Navigation for Mobile Devices, according to the example operations embodied in FIG. 3; and

FIG. 11 is a block diagram illustrating components of a machine, according to some example embodiments, able to read instructions from a machine-readable medium and perform any one or more of the methodologies for Privacy Restricted Photo Gallery Navigation for Mobile Devices discussed herein.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

Example methods and systems for Privacy Restricted Photo Gallery Navigation in wireless devices are described. The terms “mobile device” and “wireless as used herein refer to a wireless communication device such as a cellular telephone, smartphone, tablet, netbook, wireless terminal, laptop computer, a femtocell, High Data Rate (HDR) subscriber station, access point, access terminal, or other personal communication system (PCS) device.

In the following description, for purposes of explanation, numerous specific details are set forth in order to provide a thorough understanding of example embodiments. It will be evident, however, to one skilled in the art that the present invention may be practiced without these specific details.

A method and apparatus for a photo gallery user interface in mobile devices having features for restricting access to private photos and other sensitive data while intentionally sharing non-private photos and/or other data is disclosed. A mechanism is provided for restricting one or more photos in a gallery out of view before relinquishing possession of the device to viewers. The user may scroll or slide through multiple photos stored on the device and indicate which photos will not be available to the viewer. Entering a correct Personal Identification Number (PIN) at a lock screen protecting the private photos or other digital images brings the user back to an unlocked gallery.

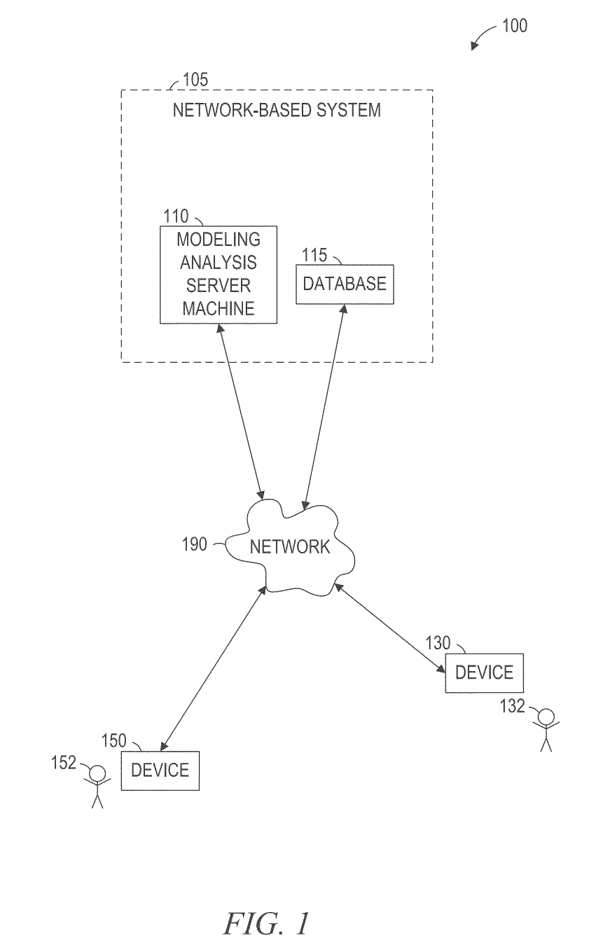

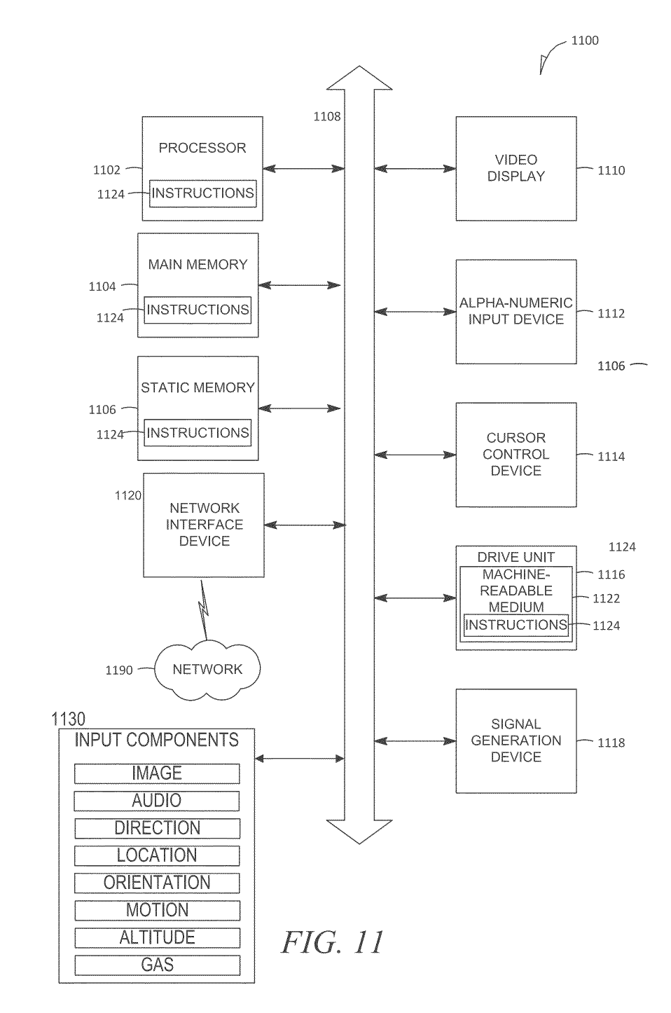

FIG. 1 is a network diagram illustrating a network environment suitable for Privacy Restricted Photo Gallery Navigation, according to some example embodiments where photos and/or other data may be stored in a cloud environment or device memory. The network environment 100 includes a network based system 105 having a Modeling Server Analysis Machine 110, a database 115, having devices 130 and 150, all communicatively coupled to each other via a network 190. In some example embodiments, users 132 and 152 are connected by the network 190 to the Modeling Server Analysis Machine 110 and the devices 130 and 150, while other devices are connected to the Modeling Server Analysis Machine 110 by a separate network. The Modeling Server Analysis Machine 110, data base 115 and the devices 130 and, 150 may each be implemented in a computer system, in whole or in part, as described below with respect to FIG. 11.

Also shown in FIG. 1 are users 132 and 152. One or both of the users 132 and 152 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, or a smart phone belonging to the user 132. Likewise, the user 152 is not part of the network environment 100, but is associated with the device 150. As an example, the device 150 may be a desktop computer, a vehicle computer, a tablet computer, a navigational device, a portable media device, or a smart phone belonging to the user 152.

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 11. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the Modeling Server Analysis Machine 110 and the device 130). The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” refers to any intangible medium that is capable of storing, encoding, or carrying instructions for execution by a machine, and includes digital or analog communication signals or other intangible media to facilitate communication of such software.

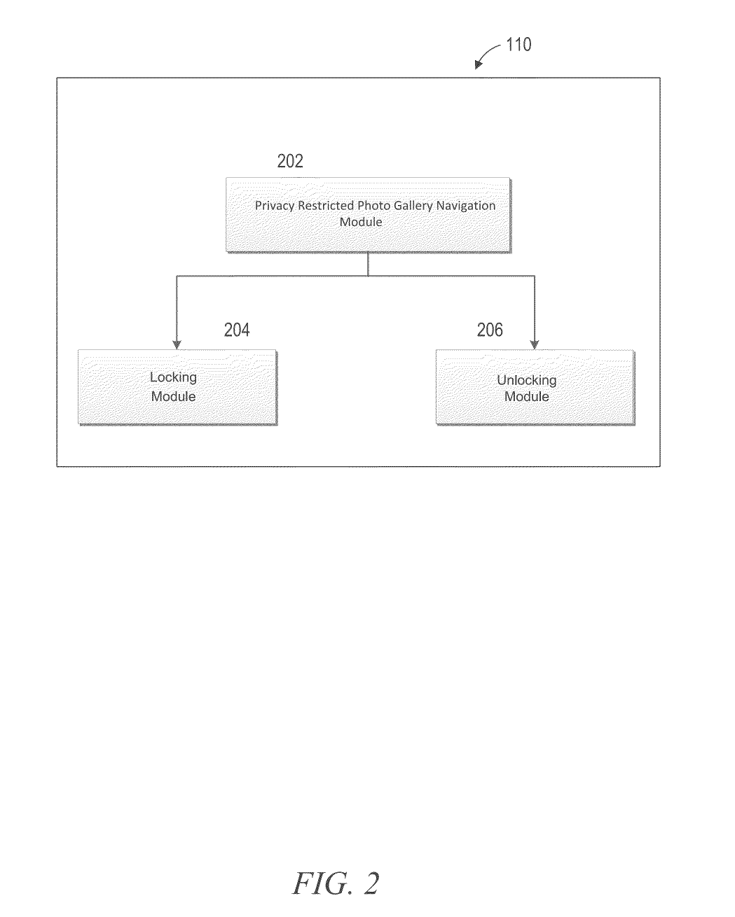

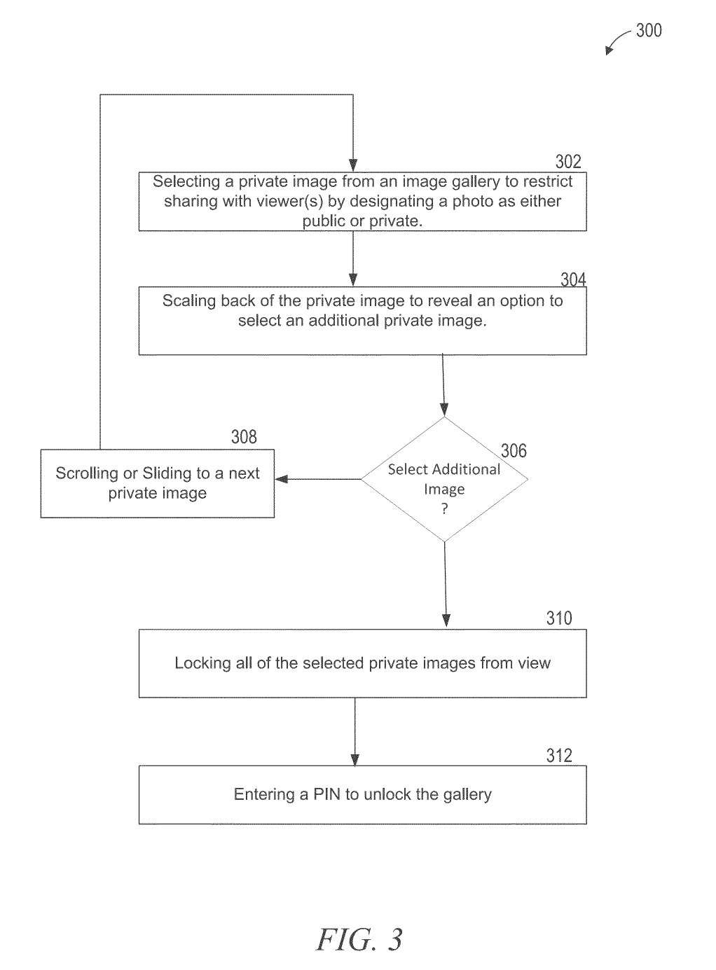

FIG. 2 is a high level block diagram illustrating component modules of the Modeling Analysis Server Machine 110 for Privacy Restricted Photo Gallery Navigation for Mobile Devices, according to some example embodiments. The Modeling Analysis Server Machine 110 may be configured as a cloud-based server machine (e.g., providing a cloud-based service analyzing stream selection commands sent by the user 132, via the portable or fixed device 130). The Modeling Analysis Server Machine 110 is shown as including a Privacy Restricted Photo Gallery Navigation Module 202, a Locking Module 204, and an Unlocking Module 206, all configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. Further details of the Modeling Analysis Server Machine 110 modules are described below with respect to FIG. 3-11.

FIG. 3 Shows a block diagram of a high level overview flow chart of Privacy Restricted Photo Gallery Navigation for Mobile Devices, according to some example embodiments. Operations in the method 300 may be performed by the Modeling Analysis Server Machine 110 and/or portable or fixed device 130 using modules described above with respect to FIG. 1-2. As shown in FIG. 3, the method 300 includes operations 302, 304, 306, 308, and 310.

A user browsing a photo gallery may select a private image and then select a restriction icon indicating the selected image will be locked to viewers. The image selected for restriction then scales back, showing the user that this image will not be shared and revealing an option to select more private images. The user may scroll, slide, or tap to select other private images for restriction from other viewers. When the user is satisfied that all potentially sensitive photos have been selected for restriction, the user locks the private information out of display. Unselected, or non-private images can then be viewed in a restricted gallery, which may be indicated by the presence of an unlock (opened lock) icon. One skilled in the art would realize that while for purposes of simplicity of explanation, the Privacy Restricted Photo Gallery Navigation methodologies are shown and described here embodied, by default, as selecting photos for restriction from a viewer, it is to be understood and appreciated that the methodologies may also be reversed, wherein in an alternative embodiment, by default, photos may be selected and marked for sharing according to the same process. In other words, a user may select, by default, a private photograph by designating a photo as either public for sharing or private for restricted viewing.

Possession of the device may now be relinquished to other viewers for as long as desired and without the necessity for uninterrupted observation of the viewer without risk of exposing private photos or other sensitive information. Sensitive information may comprise texts, documents, drawings or other stored information. The viewer may hold and touch the device while browsing all of the unrestricted content in a normal manner before returning the device to the user. Upon regaining possession of the device, the user may select to unlock the gallery, restoring unrestricted viewing of the entire content of the gallery. The user may be prompted for a PIN such that entering a correct PIN brings the user back to the unrestricted gallery. In some embodiments, the user may define a PIN specific to a locked gallery PIN that is different than a primary PIN.

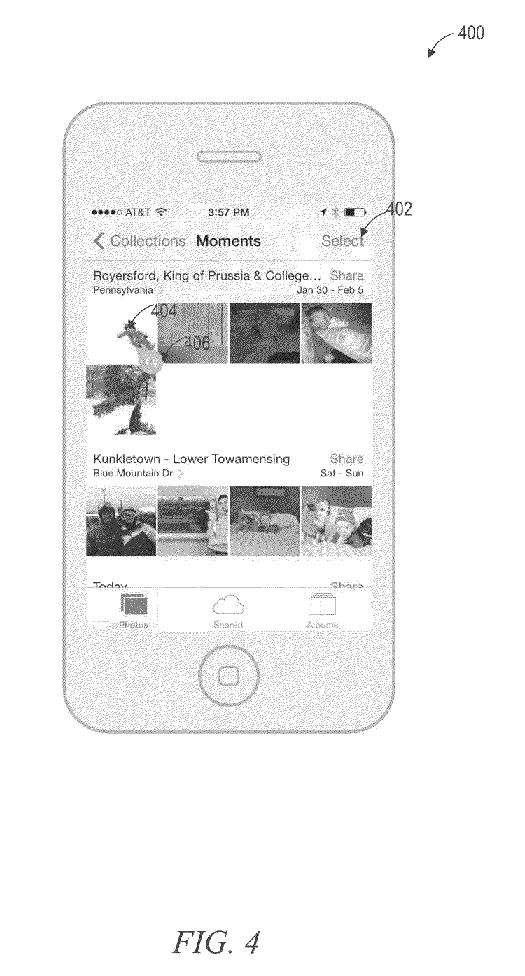

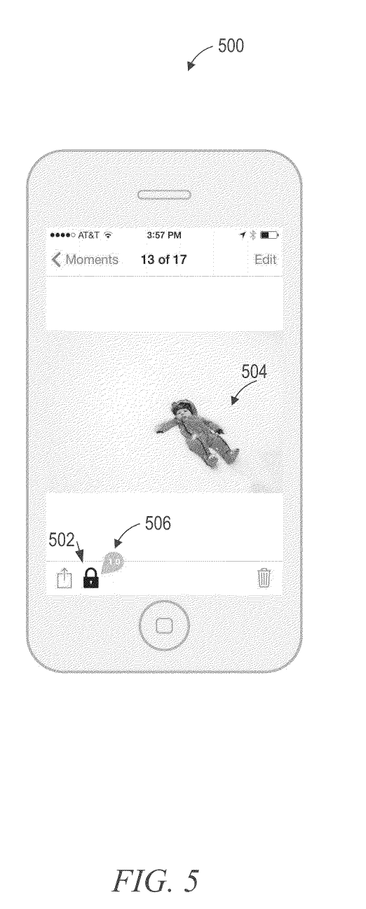

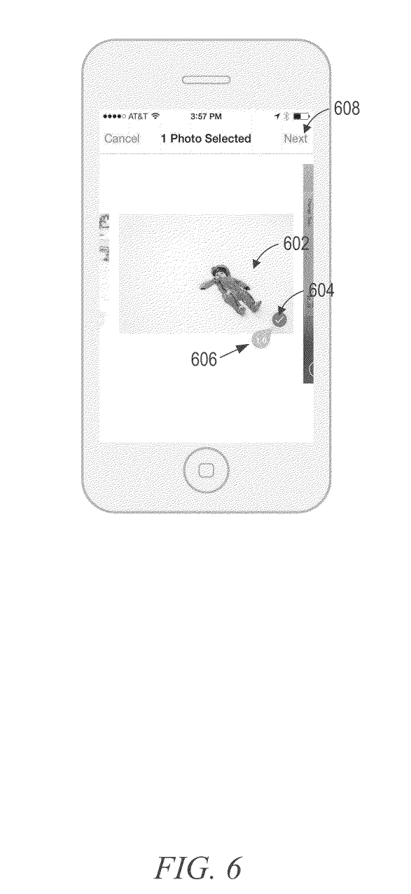

One skilled in the art would realize that while for purposes of simplicity of explanation, the Privacy Restricted Photo Gallery Navigation methodologies are shown and described here embodied as restricting access to photos on mobile devices, it is to be understood and appreciated that the methodologies are not limited to photographic image content or mobile devices. In operation 302, a user selects a private photographic image from an image gallery stored in a wireless device for restriction from sharing with viewer(s). In another embodiment, a user may select a public image to share with viewers, thus designating unselected public images as private. The term “image gallery” is used herein to mean any collection of one or more digital images, photographic images, documents, text messages, drawings or other data files. A check mark or other icon may indicate selection of the image for restriction (or inversely, sharing) when the gallery is later locked by the user in operation 310. An icon, or other indicator of the number of gallery items selected for restriction (or sharing) may also be displayed. An exemplary gallery is detailed below in FIG. 4. An exemplary gallery image is detailed below in FIG. 5. An exemplary gallery image selected for restriction is detailed below in FIG. 6. Control flow proceeds to operation 304.

In operation 304, the selected image reduces, scales back, or is otherwise indicated to have been selected for restriction (or inversely, sharing), such that an option is revealed allowing the user to continue selecting additional images for restriction (or inversely, sharing). Control flow proceeds to operation 306.

In operation 306, control flow proceeds to operation 308 if the user desires to select an additional image for restriction (or inversely, sharing). Otherwise, control flow proceeds to operation 310.

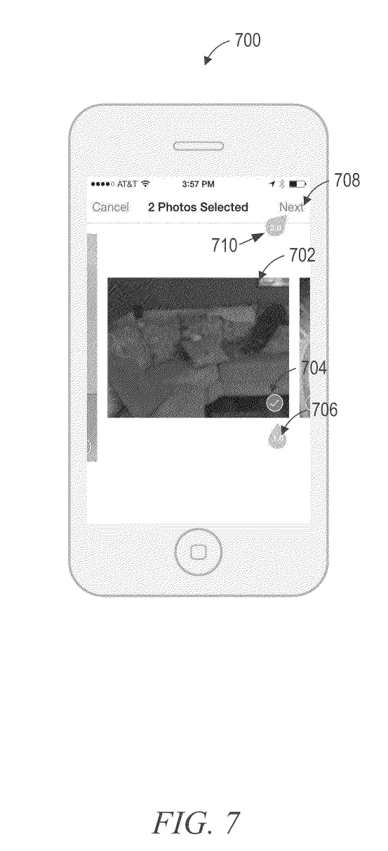

In operation 308, the user scrolls, slides, touches or otherwise identifies a next image for restriction (or inversely, sharing). Control flow returns to step 302 for selecting of the image. An additional selected image is detailed below in FIG. 7. The user may select as many images as desired for restriction (or inversely, sharing) by repeating operations 302-304 before reaching locking in operation 310.

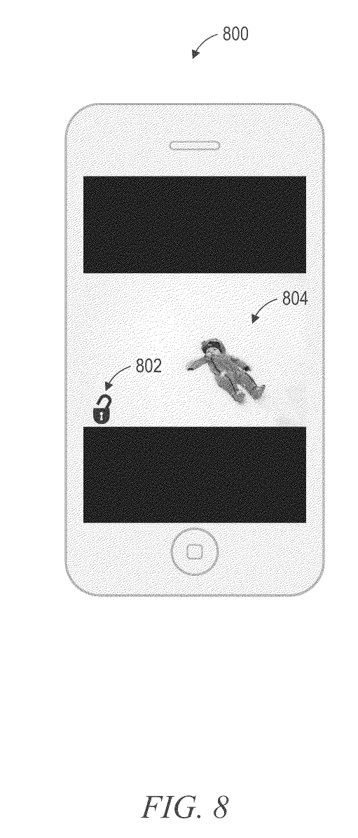

Control flow reaches operation 310 when the user is satisfied that all private images have been selected for restriction (or inversely, public images have been selected for sharing). In operation 310, a user locks all of the selected images, thus restricting viewing before relinquishing possession of the device to others by selecting a closed lock, or other icon. For example, after selecting the closed lock icon to lock the gallery, an unlock (or open lock) icon may be displayed indicating that the gallery is now locked and providing the user with an interface to unlock the gallery at an appropriate time. All of the selected private images are now hidden from view. A locked gallery showing an exemplary icon (open lock) for unlocking the gallery at an appropriate time is detailed below in FIG. 8. The user may safely relinquish possession of the device. Control flow proceeds to operation 312. In an inverse embodiment, a user may restrict images that have been selected as public.

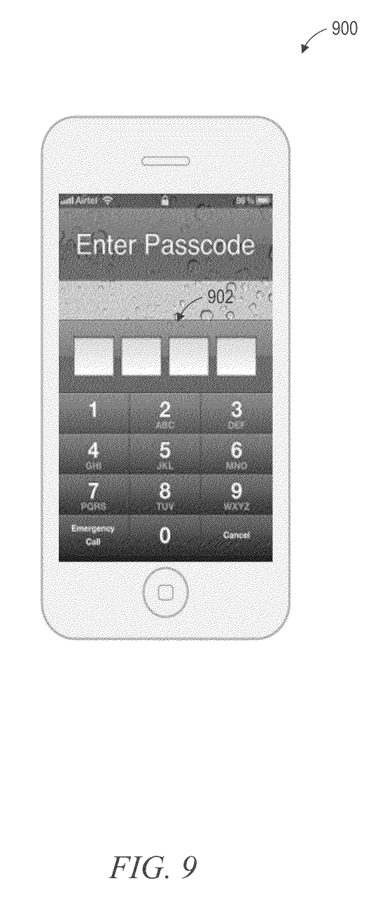

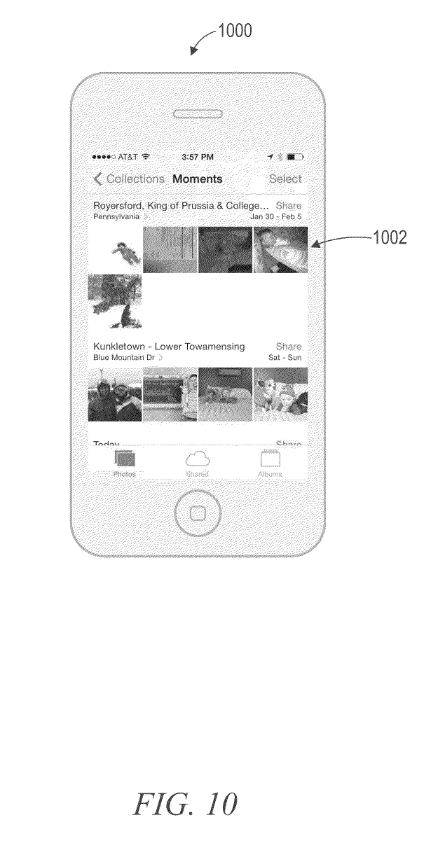

In operation 312, the user may be prompted for a PIN. A prompt for entering a gallery unlocking PIN is detailed below in FIG. 9. Entering a correct PIN brings the user back to the unrestricted gallery. A gallery returned to its unrestricted state is detailed below in FIG. 10. In some embodiments, the user may define a PIN specific to a locked gallery PIN that is different than a primary PIN.

FIG. 4 illustrates an example user interface showing an exemplary image gallery, consistent with some embodiments of the invention. In the example of FIG. 4, page 400 describes a pictorial view of an exemplary mobile phone photo gallery interface. A select icon 402 is provided for selecting images for restriction. The description may indicate that, as many parents do not wish images of their children to be made public or available on the internet, one photo of a baby 404 may be selected as a private image for locking, indicated by a bubble icon containing the numerals 1.0 406.

FIG. 5 illustrates an example user interface showing an exemplary gallery image, consistent with some embodiments of the invention. In the example of FIG. 5, page 500 describes a pictorial view of an exemplary gallery image. The description may display a closed lock icon 502 allowing the user to select the photo of the baby 504 for restriction. A bubble icon containing the numerals 1.0 506 may indicate that if the user selects the closed lock icon 502, one photo 504 in the gallery will be restricted after locking. In other words, a user chooses to restrict the photo after locking by selecting the closed lock icon 502.

FIG. 6 illustrates an example user interface showing a gallery image after selection, consistent with some embodiments of the invention. In the example of FIG. 6, page 600 describes a pictorial view of the gallery image of the baby 602 after selection using the closed lock icon of FIG. 5, as indicated by a check mark 604. A bubble icon containing the numerals 1.0 606 may indicate one photo in a first gallery will be restricted after locking. A Next prompt 608 may allow the user to continue selecting multiple images for locking.

FIG. 7 illustrates an example user interface showing an additional selected image, consistent with some embodiments of the invention. In the example of FIG. 7, page 700 describes a pictorial view of a second selected image 702 as indicated by a check mark 704. A bubble icon containing the numerals 1.0 706 may indicate one photos from this gallery will be restricted after locking, while a bubble icon containing the numerals 2.0 710 may indicate two photos total from all galleries will be restricted after locking. A Next prompt 708 may allow the user to continue selecting multiple images for locking.

FIG. 8 illustrates an example user interface showing an exemplary locked gallery image icon (open lock) for unlocking the gallery at an appropriate time, consistent with some embodiments of the invention. In the example of FIG. 8, page 800 describes a pictorial potential view of an open lock icon 802 associated with the photographic image of the baby 804, indicating that the gallery is now locked and providing the user with an interface to unlock the gallery at an appropriate time.

FIG. 9 illustrates an example user interface showing a prompt for entering a gallery unlocking PIN, consistent with some embodiments of the invention. In the example of FIG. 9, page 900 describes a pictorial view of a user interface for entering a PIN 902 to unlock the gallery.

FIG. 10 illustrates an example user interface showing a gallery returned to its unrestricted state, consistent with some embodiments of the invention. In the example of FIG. 10, page 1000 describes a pictorial view of the original unrestricted gallery 1002 having no images selected for privacy. A select icon is provided for future Privacy Restricted Navigation.

FIG. 11 is a block diagram illustrating components of a machine 1100, according to some example embodiments, able to read instructions 1124 from a machine-readable medium 1122 (e.g., a machine-readable storage medium, a computer-readable storage medium, or any suitable combination thereof) and perform any one or more of the methodologies discussed herein, in whole or in part. Specifically, FIG. 11 shows the machine 1100 in the example form of computer system within which the instructions 1124 (e.g., software, a program, an application, an applet, an app, or other executable code) for causing the machine 1100 to perform any one or more of the methodologies discussed herein may be executed, in whole or in part. In alternative embodiments, the machine 1100 operates as a standalone device or may be connected (e.g., networked) to other machines. In a networked deployment, the machine 1100 may operate in the capacity of a server machine or a client machine in a server-client network environment, or as a peer machine in a distributed (e.g., peer-to-peer) network environment. The machine 1100 may be a server computer, a client computer, a personal computer (PC), a tablet computer, a laptop computer, a netbook, a cellular telephone, a smartphone, a STB, a personal digital assistant (PDA), a web appliance, a network router, a network switch, a network bridge, or any machine capable of executing the instructions 1124, sequentially or otherwise, that specify actions to be taken by that machine. Further, while only a single machine is illustrated, the term “machine” shall also be taken to include any collection of machines that individually or jointly execute the instructions 1124 to perform all or part of any one or more of the methodologies discussed herein.

The machine 1100 includes a processor 1102 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1104, and a static memory 1106, which are configured to communicate with each other via a bus 1108. The processor 1102 may contain microcircuits that are configurable, temporarily or permanently, by some or all of the instructions 1124 such that the processor 1102 is configurable to perform any one or more of the methodologies described herein, in whole or in part. For example, a set of one or more microcircuits of the processor 1102 may be configurable to execute one or more modules (e.g., software modules) described herein.

The machine 1100 may further include a graphics, or video, display 1110 (e.g., a plasma display panel (PDP), a light emitting diode (LED) display, a liquid crystal display (LCD), a projector, a cathode ray tube (CRT), or any other display capable of displaying graphics or video). The machine 1100 may also include an alphanumeric input device 1112 (e.g., a keyboard or keypad), a cursor control device 1114 (e.g., a mouse, a touchpad, a trackball, a joystick, a motion sensor, an eye tracking device, or other pointing instrument), a storage, or drive, unit 1116, an audio signal generation device 1118 (e.g., a sound card, an amplifier, a speaker, a headphone jack, or any suitable combination thereof), and a network interface device 1120.

The storage unit 1116 includes the machine-readable medium 1122 (e.g., a tangible and non-transitory machine-readable storage medium) on which are stored the instructions 1124 embodying any one or more of the methodologies or functions described herein. The instructions 1124 may also reside, completely or at least partially, within the main memory 1104, within the processor 1102 (e.g., within the processor's cache memory), or both, before or during execution thereof by the machine 1100. Accordingly, the main memory 1104 and the processor 1102 may be considered machine-readable media (e.g., tangible and non-transitory machine-readable media). The instructions 1124 may be transmitted or received over the network 1190 via the network interface device 1120. For example, the network interface device 1120 may communicate the instructions 1124 using any one or more transfer protocols (e.g., hypertext transfer protocol (HTTP)).

In some example embodiments, the machine 1100 may be a fixed or portable computing device, such as a desktop computer, laptop computer, smart phone or tablet computer, and have one or more additional input components 1130 (e.g., sensors or gauges). Examples of such input components 1130 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1122 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1124 for execution by the machine 1100, such that the instructions 1124, when executed by one or more processors of the machine 1100 (e.g., processor 1102), cause the machine 1100 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters.” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

In one embodiment, a system comprises a Privacy Restricted Photo Navigation Module configured to receive a selection of a private image from an image gallery to restrict sharing with viewers by designating a photo as either public or private, and scale back the private image to reveal an option to select an additional private image, a Locking Module configured to restrict the selected private image(s) from viewing, and an Unlocking Module configured for receiving a Personal Identification Number (PIN) and in response to a determination that the PIN is valid, allowing the selected private images for viewing.

In another embodiment, a method for privacy restricted photo gallery navigation for a mobile device comprises receiving a selection of a private image from an image gallery to restrict sharing with viewers by designating a photo as either public or private, scaling back the private image to reveal an option to select an additional private image, restricting the selected private image(s) from viewing, and receiving a Personal Identification Number (PIN) and in response to a determination that the PIN is valid, allowing the selected private images for viewing.

In another embodiment, a non-transitory machine-readable storage medium comprising instructions that, when executed by one or more processors of a machine, cause the machine to perform operations comprising receiving a selection of a private image from an image gallery to restrict sharing with viewers by designating a photo as either public or private, scaling back the private image to reveal an option to select an additional private image, restricting the selected private image(s) from viewing, and entering a Personal Identification Number (PIN) and in response to a determination that the PIN is valid, allowing the selected private images for viewing.

In another embodiment, a count of restricted private images is shown.

In another embodiment, scrolling or sliding to a next private image is provided.

In another embodiment, an icon is associated with a private image indicating that the private image has been selected for restricted viewing.

In another embodiment, a text message, a document or a drawing is recognized as a private image.

In another embodiment, a PIN different from a primary PIN may be selected for unlocking private images.

In another embodiment, an icon for selecting a next image for restricted viewing is shown.

In another embodiment, closed lock for selecting an image for restricting viewing and an open lock for unrestricted viewing is shown.

Thus, a method and system for Privacy Restricted Navigation for Mobile Devices have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
a Privacy Restricted Photo Navigation Module configured to receive a selection of a private image from an image gallery to restrict sharing with viewers by designating a photo as either public or private, and scale back the private image to reveal an option to select an additional private image;
a Locking Module configured to restrict the selected private image(s) from viewing; and
an Unlocking Module configured for entering a Personal Identification Number (PIN) to allow the selected private images for viewing.

2. The system of claim 1, wherein:
the Privacy Restricted Photo Navigation Module is further configured to show a count of restricted private images.

3. The system of claim 1, wherein:
the Privacy Restricted Photo Navigation Module is further configured to allow scrolling or sliding to a next private image.

4. The system of claim 1, wherein:
the Privacy Restricted Photo Navigation Module is further configured to show an icon associated with a private image indicating that the private image has been selected for restricted viewing.

5. The system of claim 1, wherein:
the Privacy Restricted Photo Navigation Module is further configured to recognize a text message, a document or a drawing as a private image.

6. The system of claim 1, wherein:
the Unlocking Module is further configured to allow selection of a PIN different from a primary PIN.

7. The system of claim 1, wherein:
the Privacy Restricted Photo Navigation Module is further configured to provide an icon for selecting a next image for restricted viewing.

8. The system of claim 1, wherein:
the Privacy Restricted Photo Navigation Module is further configured to show a closed lock icon for selecting an image for restricting viewing and an open lock icon for unrestricted viewing.

9. A method for privacy restricted photo gallery navigation for a mobile device comprising:
receiving a selection of a private image from an image gallery to restrict sharing with viewers by designating a photo as either public or private;
scaling back the private image to reveal an option to select an additional private image;
restricting the selected private image(s) from viewing; and
receiving a Personal Identification Number (PIN) and in response to a determination that the PIN is valid, allowing the selected private images for viewing.

10. The method of claim 9, wherein a count of restricted private images is shown.

11. The method of claim 9, wherein scrolling or sliding to a next private image is provided.

12. The method of claim 9, wherein, an icon is associated with a private image indicating that the private image has been selected for restricted viewing.

13. The method of claim 9, wherein a text message, a document or a drawing is recognized as a private image.

14. The method of claim 9, wherein a PIN different from a primary PIN may be selected for allowing viewing of private images.

15. The method of claim 9, wherein an icon for selecting a next image for restricted viewing is shown.

16. The method of claim 9, wherein a closed lock icon for selecting an image for restricting viewing and an open lock icon for unrestricted viewing is shown.

17. A non-transitory machine-readable storage medium comprising instructions that, when executed by one or more processors of a machine, cause the machine to perform operations comprising:
receiving a selection of a private image from an image gallery to restrict sharing with viewers by designating a photo as either public or private;
scaling back the private image to reveal an option to select an additional private image;
restricting the selected private image(s) from viewing; and
receiving a Personal Identification Number (PIN) and in response to a determination that the PIN is valid, unlocking the selected private images for viewing.

18. The non-transitory machine-readable storage medium of claim 17, wherein, an icon is associated with a private image indicating that the private image has been selected for restricted viewing.

19. The non-transitory machine-readable storage medium of claim 17, wherein a text message, a document or a drawing is recognized as a private image.

20. The non-transitory machine-readable storage medium of claim 17, wherein a PIN different from a primary PIN may be selected for allowing viewing of private images.
